(19) United States
(12) Patent Application Publication
(10) Pub. No.: US 2024/0264181 A1
(43) Pub. Date: Aug. 8, 2024

(54) SEMI-AUTOMATIC ANALYSIS OF SCALE AND SLUDGE IN OILFIELD APPLICATIONS

(71) Applicant: SAUDI ARABIAN OIL COMPANY, Dhahran (SA)

(72) Inventors: Faisal Alrasheed, Dammam (SA); Tao Chen, Dhahran (SA)

(73) Assignee: SAUDI ARABIAN OIL COMPANY, Dhahran (SA)

(21) Appl. No.: 18/164,046

(22) Filed: Feb. 3, 2023

(51) Int. Cl. G01N 35/00; G01N 5/00; G01N 35/02

(52) U.S. Cl. CPC G01N 35/00584; G01N 5/00; G01N 35/02; G01N 2035/00346

(57) ABSTRACT

A system includes: one or more containers, each containing a liquid; an oven; and a sample chamber disposed in the oven, wherein a sample having an initial weight is disposed in the sample chamber, the oven is configured to heat the sample chamber to an elevated temperature, and the sample chamber is configured to hold an elevated pressure, and one or more of the liquid from the one or more containers form a treatment solution that is configured to dissolve a portion of the sample under the elevated temperature and the elevated pressure.

### BACKGROUND

Scale formation may occur on wellbore components, such as casing, production tubing, valves, pumps, and downhole completion equipments, and thereby clogging the wellbore and preventing fluid flow. Scale in oil fields may be formed either by direct precipitation from the water that occurs naturally in reservoir rocks, or as a result of produced water becoming oversaturated with scale components when two incompatible fluids meet downhole. The scale may include calcium carbonate, calcium sulfate, barium sulfate, strontium sulfate, iron sulfide, iron oxides, iron carbonate, the various silicates and phosphates and oxides, or any compound insoluble or slightly soluble in water.

For industries including oil and gas facilities, scale formation may cause challenges to flow assurance, formation damage, production and injection reduction, equipment damage and hindrance, costly workover and remediation, and sludging and emulsion stabilization. For example, scale formation may decrease the permeability of the formation, affect water production and transportation, restrict the fluid flow through an oil and gas wellbore and various portion of an oil and gas extraction system, such as drill pipes, and cause issues in production equipment, negatively affecting the well productivity and associated production cost. The severity of scale formation is partially determined by the wellbore and reservoir conditions including temperature, and pressure, and dissolved ion types and concentrations in the fluids.

In addition to scale formation, sludge accumulation is another challenge that may restrict fluid flow. Sludge is a thick, viscous emulsion that contains oil, water, sediment, and residue and is formed as a result of incompatibility between certain crude oils and strong inorganic acids used in well treatments.

To increase production, scale and sludge treatments may be necessary using a treatment solution containing a recipe of chemicals. Accordingly, an analysis may be needed to understand compositions of the scale and sludge and to evaluate an efficiency of the treatment solution. Conventionally, wet chemistry methods may be used for such analysis by applying a series of solvents and correlating with solubility. However, conventional wet chemistry methods may be resource and time consuming, labor intensive, and may require large amount of solvent. As such, an automated, user and cost friendly, and resource saving method, with minimized solvent consuming, is needed.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In some aspect, embodiments disclosed herein relate to a system, including: one or more containers, each containing a liquid; an oven; and a sample chamber disposed in the oven, wherein a sample having an initial weight is disposed in the sample chamber, the oven is configured to heat the sample chamber to an elevated temperature, and the sample chamber is configured to hold an elevated pressure, and one or more of the liquid from the one or more containers form a treatment solution that is configured to dissolve a portion of the sample under the elevated temperature and the elevated pressure.

In some aspects, embodiments described herein relate to a system, wherein the sample includes at least one of a scale and a sludge.

In some aspects, embodiments described herein relate to a system, wherein the liquid in each of the containers include at least one selected from a group of toluene, dichloromethane, toluene, methane, chloroform, an acid, a base, a corrosion inhibitor, a scale inhibiter, a biocide, and a chelating agent.

In some aspects, embodiments described herein relate to a system, further including a gas cylinder containing an inert gas configured to fill or purge the sample chamber.

In some aspects, embodiments described herein relate to a system, further including a collection vial configured to collect an effluent from the sample chamber.

In some aspects, embodiments described herein relate to a system, further including a sample tray configured to hold a plurality of the samples and configured to insert each of the sample to the sample chamber in sequence.

In some aspects, embodiments described herein relate to a system, further including a control unit configured to control at least one parameter of the system, wherein the parameter is selected from a group of the elevated temperature, the elevated pressure, a flush percentage, a static time, type and amount of the liquid in formation of the treatment solution, a preheat time, a purge operation of an inert gas, and a cycle number.

In some aspects, embodiments described herein relate to a system, further including a protective layer, wherein the protective layer is coated on a location selected from a group of an inner surface of the sample chamber, an inner surface of the one or more containers, and an inner surface of a connection member configured to provide connection in the system, and the protective layer consists essentially of a metal.

In some aspects, embodiments described herein relate to a method, including: disposing a sample in a sample chamber in an oven, the sample having an initial weight; immersing the sample in a treatment solution formed by mixing one or more liquids from one or more containers; treating the sample under an elevated temperature and an elevated pressure; and weighing the sample after the treating to obtain a final weight of the sample.

In some aspects, embodiments described herein relate to a method, wherein the sample includes at least one of a scale and a sludge.

In some aspects, embodiments described herein relate to a method, wherein the liquids include at least one selected from a group of toluene, dichloromethane, toluene, methane, chloroform, an acid, a base, a corrosion inhibitor, a scale inhibiter, a biocide, and a chelating agent.

In some aspects, embodiments described herein relate to a method, further including flowing an inert gas to the sample chamber to provide an inert environment around the sample.

In some aspects, embodiments described herein relate to a method, further including collecting effluent of the treatment solution to a collection vial.

In some aspects, embodiments described herein relate to a method, further including holding a plurality of the samples on a sample tray, and performing one or more steps of the disposing, the immersing, the treating, and the weighing in sequence for each of the sample.

In some aspects, embodiments described herein relate to a method, further including controlling, using a control unit, at least one of the elevated temperature, the elevated pressure, a flush percentage, a static time, type and amount of liquid in formation of the treatment solution, a preheat time, a purge operation of an inert gas, and a cycle number.

In some aspects, embodiments described herein relate to a method, further including coating a protective layer, wherein the protective layer is coated on a location selected from a group of an inner surface of the sample chamber, an inner surface of the one or more containers, and an inner surface of a connection member, and the protective layer consists essentially of a metal.

Other aspects and advantages of the claimed subject matter will be apparent from the following description and the appended claims.

### BRIEF DESCRIPTION OF DRAWINGS

FIG. 1 shows a schematic diagram of a system according to one or more embodiments.

FIG. 2 shows a computing system 190 according to one or more embodiments of the present disclosure.

FIG. 3 shows a method according to one or more embodiments.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

The present disclosure generally relates to a system and a method for sample analysis and to optimize a recipe of chemicals for treatment. The system and method may be semi-automated and is capable of operating in an unattended manner. The system and method may consume less solvents, require less contact time, and cause less exposure to harmful chemicals for operators.

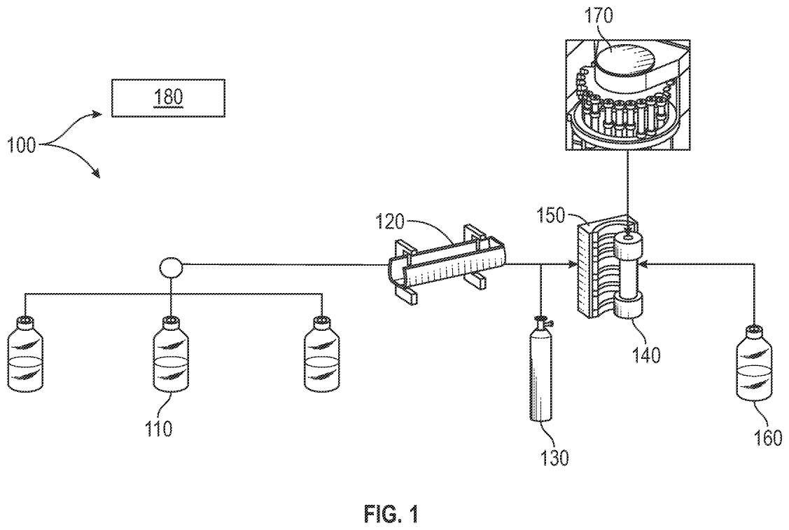

FIG. 1 shows a schematic diagram of a system 100 according to one or more embodiments, which may be used to perform methods in accordance with one or more embodiments of the present disclosure. In one or more embodiments, one or more of the modules and/or elements shown in FIG. 1 may be omitted, repeated, and/or substituted. As shown in FIG. 1, the system 100 may include one or more containers 110, each containing a liquid. In one or more embodiments, the liquid may comprise organic and/or inorganic materials. For example, the liquid may include one or more organic solvents, for example, toluene, dichloromethane, toluene, methane, and chloroform. The liquid may include an acid or a base dissolved in aqueous or nonaqueous solvents. The liquid may include chemicals for oilfield applications, for example, corrosion inhibitors, scale inhibiters, biocides, iron control agents, water wetting agents, resins, gas hydrate inhibitors or dissolvers, wax inhibitors or dissolvers, oxidizers, reducers, and chelating agents. In some embodiments, one or more liquid from the one or more containers may be mixed to produce a treatment solution having a recipe of chemicals for treatment. In some embodiments, the mixing of liquids may be automated and controlled.

In one or more embodiments, the liquid may comprise a hydrogen halide, such as hydrofluoric acid (HF), hydrochloric acid (HCl), hydrobromic acid (HBr), hydroiodic acid (HI), a halogen oxoacid, such as hypofluorous acid (HFO), hypochlorous acid (HClO), chlorous acid (HClO₂), chloric acid (HClO₃), perchloric acid (HClO₄), and corresponding analogs for bromine and iodine, sulfuric acid (H₂SO₄), fluorosulfuric acid (HSO₃F), nitric acid (HNO₃), phosphoric acid (H₃PO₄), fluoroantimonic acid (HSbF₆), fluoroboric acid (HBF₄), hexafluorophosphoric acid (HPF₆), chromic acid (H₂CrO₄), boric acid (H₃BO₃), sulfonic acids having a formula RS(═O)₂—OH where R is an organic radical, methanesulfonic acid (or mesylic acid, CH₃SO₃H), ethanesulfonic acid (or esylic acid, CH₃CH₂SO₃H), benzenesulfonic acid (or besylic acid, C₆H₅SO₃H), p-toluenesulfonic acid (or tosylic acid, CH₃C₆H₄SO₃H), trifluoromethanesulfonic acid (or triflic acid, CF₃SO₃H), polystyrene sulfonic acid (sulfonated polystyrene, [CH₂CH(C₆H₄)SO₃H]ₙ), carboxylic acids having a general formula R—C(O)OH where R is an organic radical, acetic acid (CH₃COOH), citric acid (C₆H₈O₇), formic acid (HCOOH), gluconic acid HOCH₂—(CHOH)₄—COOH, lactic acid (CH₃—CHOH—COOH), oxalic acid (HOOC—COOH), tartaric acid (HOOC—CHOH—CHOH—COOH), halogenated carboxylic acids whose halogenation may be at alpha position with increased acid strength and derivatives, such as fluoroacetic acid, trifluoroacetic acid, chloroacetic acid, dichloroacetic acid, trichloroacetic acid, vinylogous carboxylic acid having a carbon-carbon double bond separating the carbonyl and hydroxyl groups, ascorbic acid, and other acids as needed.

In one or more embodiments, the system 100 may include one or more sample chamber 140, in which a sample is placed. Non-limiting examples of the sample may include rock, scale, sludge, deposit, oil-water-based samples, corrosion coupon, scale coupon, or any other materials of interest. The sample chamber may be disposed in an oven with capability of temperature control. The sample chamber may include an inlet and an outlet, and may be fluidly connected to one or more of the containers 110, an inert gas source 130, or a vacuum generated by pump. In some embodiments, the treatment solution may be obtained by mixing liquids from the containers and subsequently introduced to the sample chamber, such that the sample is entirely immersed in the treatment solution. Controlled temperature and pressure, for example elevated temperature and pressure, may be applied to the sample in the sample chamber. In some embodiments, nitrogen or other inert gas may be introduced from the inert gas source to the sample chamber to fill or purge the sample chamber. In some embodiments, a vacuum may be provided to remove oxygen or air from the sample chamber prior to operation.

In one or more embodiments, the sample may be disposed on a filter in the sample chamber 140. The filter may be made of a polymer, for example, cellulose, polytetrafluoroethylene, polycarbonate, or nylon. A filter insertion tool may be used to introduce the filter to a bottom of the sample chamber. In some embodiments, the filter insertion tool may be incorporated to or inside the sample chamber. The filter insertion tool may be modified to include material such as ceramic or stainless steel with various grain sizes. In some embodiments, the grain size may be in micron scale, such as 0.45 micron, or smaller, or larger.

In one or more embodiments, the system 100 may include a sample tray 170, holding one or more samples. The one or more samples may be introduced to the sample chamber in sequence for analysis. In some embodiments, the loading of samples to the sample chamber may be automated, and the order of loading may be controlled.

In one or more embodiments, the system 100 may include a pump 120. In some embodiments, the pump may be used in treatment solution formation by mixing of the liquids from the one or more containers, or in introducing the treatment solution to the sample chamber. In some embodiments, the pump may be used to generate a vacuum environment in the sample chamber. In some embodiments, the pump may be capable of generating high pressure and/or may be equipped with self-cleaning functions, for example, back flushing.

In one or more embodiments, the system 100 may include one or more collection vial 160. After each measurement, the collection vial may collect an effluent from the sample chamber for further characterization or analysis. The effluent refers to a solution obtained after treating the sample with the treatment solution under controlled temperature and pressure.

In one or more embodiments, the elements in the system 100 may be directly and/or indirectly in communication with each other. In some embodiments, the one or more containers may be in direct fluid communication with, or in indirect communication through the pump with, the sample chamber in the oven. In some embodiments, the treatment solution may be obtained directly or indirectly from the one or more containers and may be flowed through the sample chamber. In some embodiments, the control unit may be disposed in between any two elements of the system, controlling temperature, pressure, and other parameters during analysis. In one or more embodiments, the control unit may be in direct communication (wired or wireless) with one or more elements in the system 100, or the control unit may be in indirect communication through one or more transmission nodes with elements of the system 100.

In one or more embodiments, the system 100 may include one or more of connection members, for example, tubings, pipes, valves, and casings, connecting elements of the system. The connection members may be made of metal, steel, plastic, polymer, glass, or any materials commonly known in the art.

According to one or more embodiments, the system 100 described herein may be used for analyzing a sample, such as a sample comprising scale and/or sludge, treating the sample with a treatment solution such that the treatment solution dissolves at least a portion of the sample, such as a portion of the scale and/or sludge on the sample, and for optimizing the treatment solution to determine a recipe of chemicals to be used for efficient treatment in downhole applications. To evaluate an efficiency of the treatment solution, the sample having an initial weight may be disposed in the sample chamber. The treatment solution may contain one or more liquid from the one or more containers and may be introduced to the sample chamber. The sample immersed in the treatment solution may be treated under elevated temperature and pressure. A final weight of the sample after treatment may be compared with the initial weight, and the efficiency of the treatment solution may be evaluated based on a ratio of the final weight versus the initial weight. A plurality of treatment may be applied to determine a recipe of chemicals that efficiently dissolve the scale and/or sludge on the sample.

According to one or more embodiments, the elements in the system 100 described herein may be made of materials that are commonly know to one having ordinary skill in the art. However, because the treatment solution is applied to dissolve scale and/or sludge, it may contain chemicals that cause damage to the system. Further, elevated temperature and pressure may cause degradation of certain materials in the system. As such, according to one or more embodiments of the present disclosure, elements in the system may be modified with a protective layer. For example, an inner surface of the containers, an inner surface of the sample chamber, and/or an inner surface of the connection members, may be modified with a protective layer. The protective layer may be made of any material that is stable under elevated temperature and pressure, acid, base, and other chemicals used in the system. In one or more embodiments, the protective layer may be made of metal, such as Hastelloy, chromium-based steels, stainless steels, or any other metal of interest.

In one or more embodiments, the system 100 may include one or more control units 180. In one or more embodiments, the system 100 may include one or more sensor associated with the control unit. In some embodiments, the control unit may be a temperature control unit, controlling a temperature at one or more elements of the system. For example, the temperature control unit may control a temperature of the oven, such that the sample in the sample chamber is at elevated temperature. In some embodiments, the control unit may be a pressure control unit, controlling a pressure (elevated pressure or vacuum) at one or more elements of the system. For example, the pressure control unit may control a pressure in the sample chamber, such that the sample is treated under elevated pressure. In some embodiments, a flow restrictor may be used to maintain the pressure inside the sample chamber. In some embodiments, the control unit may be an operation control unit, controlling or optimizing one or more parameters at one or more elements of the system during operation. For example, the control unit may be used to control or optimize one or more of a soaking time of the sample in the treatment solution, a flush percentage, type and amount of liquids or mixing of the liquids, a preheat time, a purge operation, and a cycle number. The soaking time may be a static time or a dynamic time. In a static mode, the sample is soaked in the treatment solution at elevated temperature and pressure without outflow of the treatment solution. In a dynamic mode, the treatment solution continuously flows through the sample in the sample chamber. The flush percentage refers to a flush volume, expressed as a percentage of the flush volume versus a volume of the sample chamber. The preheat time refers to a time before the elevated temperature reaches equilibrium.

In one or more embodiments, the control unit 180 may be used to collect, transfer, and process data. For example, the control unit 180 may be configured with a computing system 190, located at a remote location and connected to the other elements over a network system. The network system may be a cloud-based interface performing processing at a remote location from the well site and connected to the other elements over a network. Data may be transferred between a computing system 190 and one or more other elements of the system 100 using a portable memory storage device, such as a jump drive, or wirelessly. In some embodiments, the computing system 190 may be implemented on remote or handheld devices (e.g., laptop computer, smart phone, personal digital assistant, tablet computer, or other mobile device), desktop computers, servers, blades in a server chassis, or any other type of computing device or devices that includes at least the minimum processing power, memory, and input and output devices to perform one or more embodiments of the invention.

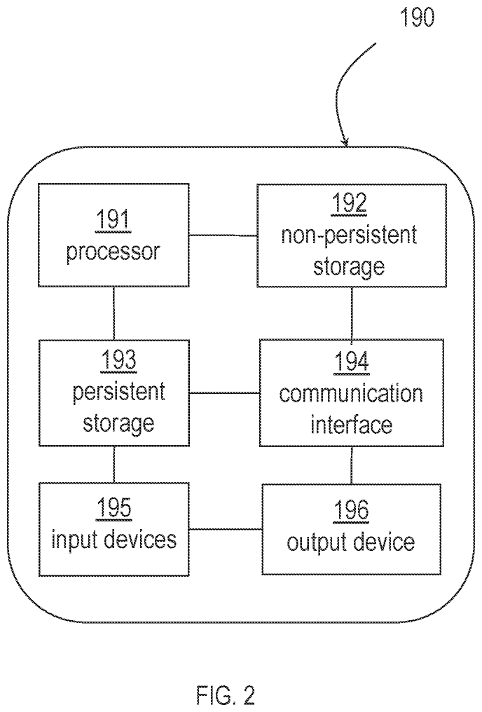

FIG. 2 shows an example of the computing system 190 according to one or more embodiments of the present disclosure. The computing system 190 may include one or more computer processors 191, non-persistent storage 192 (e.g., random access memory (RAM), cache memory, or flash memory), one or more persistent storage 193 (e.g., a hard disk), a communication interface 194, and numerous other elements and functionalities. The computer processor 191 may be an integrated circuit for processing instructions. The computing system 190 may also include one or more input devices 195, such as a touchscreen, keyboard, mouse, microphone, touchpad, electronic pen, or any other type of input device. Further, the computing system 190 may include one or more output devices 196, such as a screen (e.g., a liquid crystal display (LCD), a plasma display, or touchscreen), a printer, external storage, or any other output device. One or more of the output device may be the same or different from the input device.

The computing system 190 may be connected to a network system (e.g., a local area network (LAN), a wide area network (WAN) such as the Internet, mobile network, or any other type of network) via a network interface connection (not shown). For example, the input device 195 may be coupled to a receiver and a transmitter used for exchanging communication with one or more peripherals connected to the network system. The receiver may receive information relating to one or more samples. The transmitter may relay information received by the receiver to other elements in the computing system 190. Further, the computer processor 191 may be configured for performing or aiding in implementing the processes described herein.

The computing system 190 may implement and/or be connected to a data repository. For example, one type of data repository is a database. A database is a collection of information configured for ease of data retrieval, modification, re-organization, and deletion. In some embodiments, the database includes published/measured data relating to the method and the system as described herein (e.g., temperature, pressure, changes in temperature or pressure, selection and mixing of fluids, accelerated heating schedule and other operation parameters, or other sample analysis data).

Computer readable software instructions for performing the methods according to embodiments of the present disclosure may be implemented on and/or stored on the computing system 190. The computing system 190 may send commands to one or more elements in the system 100, such as the oven 150, to increase a temperature when performing the method disclosed herein. For example, the computing system 190 may implement instructions for controlling a temperature and/or pressure in the sample chamber according to an accelerated heating schedule that includes one or more heating phases, and/or instructions for multiple measurements.

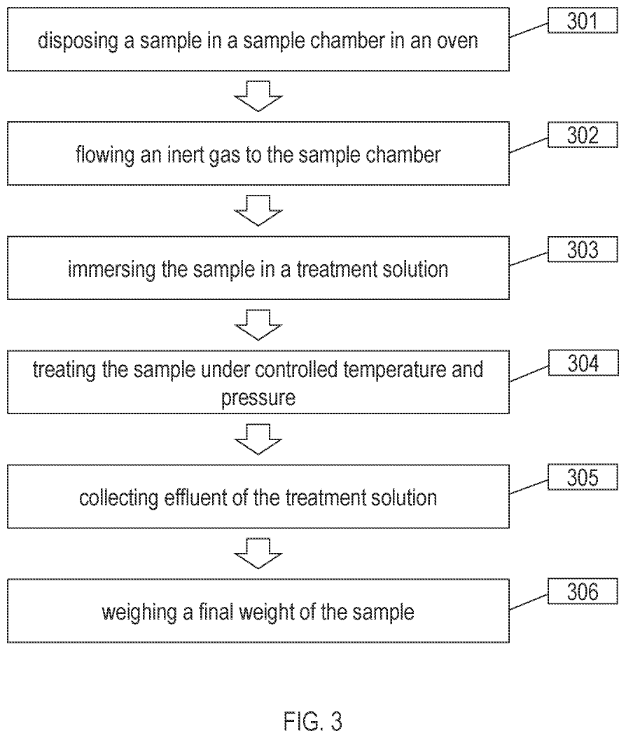

FIG. 3 shows an example of a method according to one or more embodiments of the present disclosure that is performed by the system in accordance with one or more embodiments described herein. One or more of the steps shown in FIG. 3 may be omitted, repeated, performed in other orders, and/or substituted. As shown in FIG. 3, the method may include a step 301, disposing a sample in a sample chamber in an oven. Prior to disposing in the sample chamber, the sample may be pretreated, for example, by grinding or pulverizing. Prior to disposing in the sample chamber, the sample may be dried and weighted to obtain an initial weight of the sample. In one or more embodiments, the sample may include scale and/or sludge, comprising one or more of calcium carbonate, calcium sulfate, barium sulfate, strontium sulfate, iron sulfide, iron oxides, iron carbonate, the various silicates and phosphates and oxides, or any compound insoluble or slightly soluble in water. The sample may be collected from a wellbore component of interest, such as casing, production tubing, valves, pumps, and downhole completion equipments. In some embodiments, multiple samples may be taken from different locations in the wellbore component of interest to compare scale and/or sludge formation at the different locations, where each sample may undergo separate processes in sequence.

In one or more embodiments, the method may include a step 302, flowing an inert gas to the sample chamber to provide an inert environment around the sample. The inert gas may be introduced from a container, for example a gas cylinder, to the sample chamber with controlled pressure, flow rate, or time. In some embodiments, the inert gas is flowed to the sample chamber before measurements to replace air in the sample chamber. In some embodiments, the inert gas is flowed to the sample chamber between any two measurements to purge the sample chamber.

In one or more embodiments, the method may include a step 303, immersing the sample in a treatment solution obtained by mixing one or more liquid from one or more containers.

In one or more embodiments, the method may include a step 304, treating the sample under controlled temperature and pressure, for example, elevated temperature and pressure. In some embodiments, the treating may be performed according to one or more accelerated schedule. Before treating, a temperature and a pressure of the sample may be referred to as an initial temperature and an initial pressure, respectively. The initial temperature may be at room temperature. In some embodiments, the initial temperature may be in a range of 20° C. to 30° C., for example, 25° C. The initial pressure may be atmosphere pressure, for example, 1 atm.

The accelerated schedule according to one or more embodiments of the present disclosure may have one or more stages (or phases). In some embodiments, the accelerated schedule may include treating the sample in the oven in a first stage, in which the temperature may be increased from the initial temperature to a first temperature at an accelerated rate. For example, the accelerated rate in the first heating phase may be at least 1 ºC per minute, such as, 1° C. per minute to 200° C. per minute, or 10° C. per minute to 100° C. per minute, or 25° C. per minute to 100° C. per minute. The first temperature may be any temperature higher than the initial temperature, for example, a temperature selected from the range of 25° C. to 400° C., or about 40° C. to 200° C. For example, in some embodiments, the first heating phase may include increasing the temperature from the initial temperature 25° C. to a first temperature of about 200° C. at a rate of about 20° C. per minute.

In one or more embodiments, the accelerated schedule may include a second heating phase, holding the oven temperature at a second temperature, such that the sample may be constantly heated at the second temperature during a time period. In some embodiments, the second temperature may be the same as the first temperature. The second temperature may be any temperature higher than the initial temperature, for example, a temperature selected from the range of 25° C. to 400° C., or about 40° C. to 200° C. While only an example of two stages is described herein, the accelerated schedule may include more stages of heating, holding, or cooling, as needed, or more stages with different pressures.

In some embodiments, the accelerated schedule may include holding the pressure in the sample chamber at a first pressure that is higher than atmosphere pressure, for example, a pressure selected from a range of 500 psi to 3000 psi.

In one or more embodiments, the method may include a step 305, collecting effluent of the treatment solution. The effluent may be subjected to further characterization, for example, compositional analysis using spectroscopy.

In one or more embodiments, the method may include a step 306, weighing the sample after the immersing and the treating processes described herein to obtain a final weight of the sample after treated by the treatment solution. The final weight may be compared with the initial weight to evaluate an efficiency of treatment under the treatment solution.

In one or more embodiments, the method may include analyzing the sample after the immersing and the treating steps to obtain a composition of the sample after treatment. The analyzing may be performed by chromatography, spectroscopy, electrochemistry, or any other devices and methods of interest, for example, elemental analysis using X-ray fluorescence (XRF). The analyzing may determine an outcome of the treatment and a quality of the sample after treatment, and provides information on whether further treatment is needed, oxidation takes place, elemental sulfur is formed, and scale is dissolved.

In one or more embodiments, the method may include coating a protective layer according to one or more embodiments previous described on an inner surface of one or more components in the system described herein. For example, an inner surface of the containers, an inner surface of the sample chamber, and/or an inner surface of the connection members, may be coated with a protective layer.

In one or more embodiments, the method may include repeating one or more of the aforementioned steps to optimize a recipe of chemicals in the treatment solution. For example, a plurality of treatment solutions may be applied to a same sample or different samples in sequence to evaluate the performance of each treatment solution, and the final weights of the sample after each cycle may be compared. In one or more embodiments, if a ratio of the final weight to the initial weight is low after treatment with a specific treatment solution, it is determined that a high efficiency is achieved with the specific treatment solution. By repeating the steps, an optimized recipe of chemicals of the treatment solution may be determined.

### EXAMPLES

The following examples are merely illustrative and should not be interpreted as limiting the scope of the present disclosure.

### Example 1

A sample was analyzed according to one or more embodiments of the system and the method described in the present disclosure. The sample was disposed on a cellulose filter in a sample chamber inside an oven. The sample was a sludge sample comprising calcium sulphate at a weight percentage of 81 wt %. The sample was treated using the parameters shown in Table 1.

TABLE 1
Method parameters for sludge dissolution.

| Parameter | Value | |
|---|---|---|
| Flush percentage | 50% | |
| Static time | 50 | min |
| Pressure | 1000 | psi |
| Temperature | 40° | C. |
| Treatment solution | Dichloromethane | |
| Preheat | 1 | min |
| Purge | 20 | s |

| | |
|---|---|
| Cycle | 3 |

After treatment, the sludge sample had a composition as shown in Table 2, determined by X-ray fluorescence (XRF) spectroscopy.

TABLE 2
XRF elemental composition of the sludge sample.

| Element | wt % |
|---|---|
| O | 45.4 |
| Ca | 20.3 |
| S | 16.6 |
| C | 16.0 |
| Cl | 0.9 |
| Na | 0.5 |
| Sr | 0.1 |
| Fe | 0.1 |
| Mg | <0.1 |
| K | <0.1 |
| Si | <0.1 |
| P | <0.1 |

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A system, comprising:
one or more containers, each containing a liquid;
an oven; and
a sample chamber disposed in the oven,
wherein
a sample having an initial weight is disposed in the sample chamber,
the oven is configured to heat the sample chamber to an elevated temperature, and the sample chamber is configured to hold an elevated pressure, and
one or more of the liquid from the one or more containers form a treatment solution that is configured to dissolve a portion of the sample under the elevated temperature and the elevated pressure.

2. The system of claim 1, wherein the sample comprises at least one of a scale and a sludge.

3. The system of claim 1, wherein the liquid in each of the containers comprise at least one selected from a group of toluene, dichloromethane, toluene, methane, chloroform, an acid, a base, a corrosion inhibitor, a scale inhibiter, a biocide, and a chelating agent.

4. The system of claim 1, further comprising a gas cylinder containing an inert gas configured to fill or purge the sample chamber.

5. The system of claim 1, further comprising a collection vial configured to collect an effluent from the sample chamber.

6. The system of claim 1, further comprising a sample tray configured to hold a plurality of the samples and configured to insert each of the sample to the sample chamber in sequence.

7. The system of claim 1, further comprising a control unit configured to control at least one parameter of the system, wherein the parameter is selected from a group of the elevated temperature, the elevated pressure, a flush percentage, a static time, type and amount of the liquid in formation of the treatment solution, a preheat time, a purge operation of an inert gas, and a cycle number.

8. The system of claim 1, further comprising a protective layer, wherein
the protective layer is coated on a location selected from a group of an inner surface of the sample chamber, an inner surface of the one or more containers, and an inner surface of a connection member configured to provide connection in the system, and
the protective layer consists essentially of a metal.

9. A method, comprising:
disposing a sample in a sample chamber in an oven, the sample having an initial weight;
immersing the sample in a treatment solution formed by mixing one or more liquids from one or more containers;
treating the sample under an elevated temperature and an elevated pressure; and
weighing the sample after the treating to obtain a final weight of the sample.

10. The method of claim 9, wherein the sample comprises at least one of a scale and a sludge.

11. The method of claim 9, wherein the liquids comprise at least one selected from a group of toluene, dichloromethane, toluene, methane, chloroform, an acid, a base, a corrosion inhibitor, a scale inhibiter, a biocide, and a chelating agent.

12. The method of claim 9, further comprising flowing an inert gas to the sample chamber to provide an inert environment around the sample.

13. The method of claim 9, further comprising collecting effluent of the treatment solution to a collection vial.

14. The method of claim 9, further comprising holding a plurality of the samples on a sample tray, and performing one or more steps of the disposing, the immersing, the treating, and the weighing in sequence for each of the sample.

15. The method of claim 9, further comprising controlling, using a control unit, at least one of the elevated temperature, the elevated pressure, a flush percentage, a static time, type and amount of liquid in formation of the treatment solution, a preheat time, a purge operation of an inert gas, and a cycle number.

16. The method of claim 9, further comprising coating a protective layer, wherein
the protective layer is coated on a location selected from a group of an inner surface of the sample chamber, an inner surface of the one or more containers, and an inner surface of a connection member, and
the protective layer consists essentially of a metal.
